(19) United States
(12) Patent Application Publication
(10) Pub. No.: US 2013/0110488 A1
(43) Pub. Date: May 2, 2013

(54) METHOD FOR UTILIZING A PHYSICAL DEVICE TO GENERATE PROCESSED DATA

(71) Applicants: MingXiang Shen, Hangzhou City (CN); ZhiQiang Zheng, Hangzhou City (CN)

(72) Inventors: MingXiang Shen, Hangzhou City (CN); ZhiQiang Zheng, Hangzhou City (CN)

(21) Appl. No.: 13/283,548

(22) Filed: Oct. 27, 2011

(51) Int. Cl. G06G 7/62

(52) U.S. Cl. 703/14

(57) ABSTRACT

A method for utilizing a physical device to generate processed data and a simulated device to output the processed data to the application program making the request. The simulated device is generated according to a simulated bus of the computer architecture, and comprises physical characteristics such as vendor identification (VID) and product identification (PID). When the simulated device is generated, the simulated device is perceived as a real physical device being installed, and the simulated device can be accessed by multiple applications at the same time.

### BACKGROUND OF THE INVENTION

1. Field of the Invention

The present invention is related to a method for utilizing a physical device to generate processed data, and more particularly, to a method for utilizing a physical device to generate processed data and the processed data is outputted by a simulated device comprising physical characteristics.

2. Description of the Prior Art

Computer peripheral devices can normally be accessed by one application program at a time. For instance, if a user is video conferencing with a web camera in a first application program such as Skype, the web camera cannot be used by a second application program such as Microsoft MSN messenger at the same time.

Multiple peripheral devices of the same kind, e.g. two web cameras, maybe installed for multiple application programs to access at the same time. However, the use of multiple peripheral devices of the same kind increases cost and occupies more peripheral slots.

### SUMMARY OF THE INVENTION

The present invention discloses a method for utilizing a physical device to generate processed data. The method comprises generating a simulated bus to interact with the physical device; generating the simulated device to interact with the simulated bus; a first application program sending a request to the simulated device; the simulated device requesting a control module to activate the physical device to obtain data according to the request; the control module activating the physical device to obtain the data after being requested by the simulated device; and the control module processing the data obtained by the physical device to generate the processed data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating computer architecture according to an embodiment of the present invention.

FIG. 2 is a flowchart illustrating a method for utilizing a physical device to generate processed data according to an embodiment of the present invention.

FIG. 3 is a diagram illustrating computer architecture according to an embodiment of the present invention.

### DETAILED DESCRIPTION

The principle of the present invention is to generate a simulated device according to a computer bus of computer architecture, for the simulated device to comprise characteristics of a real physical peripheral device.

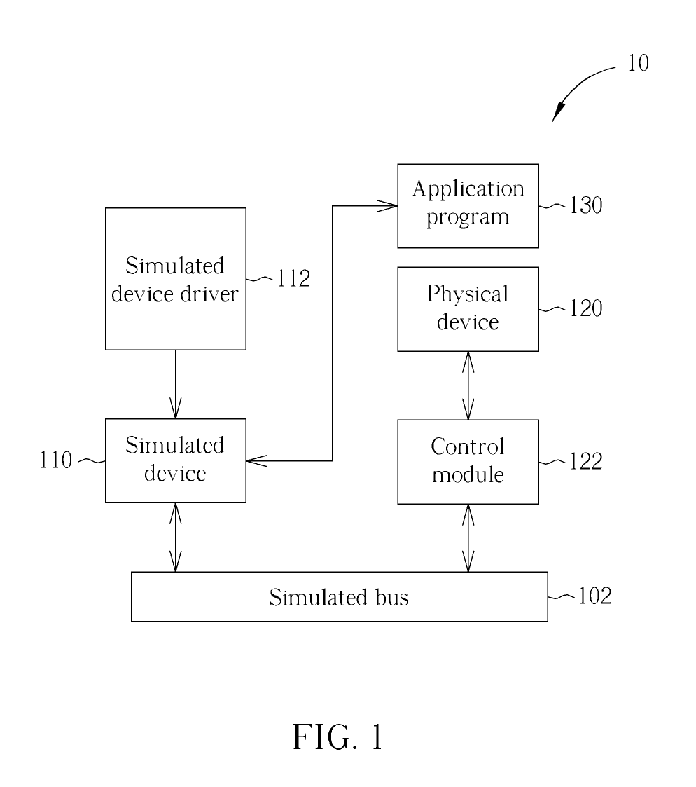

Please refer to FIG. 1. FIG. 1 is a diagram illustrating computer architecture 10 according to an embodiment of the present invention. The computer architecture 10 comprises a simulated bus 102, a simulated device 110, a simulated device driver 112, a physical device 120, a control module 122 and an application program 130. The simulated bus 102, simulated device 110, the control module 122 and the application 130 can be realized in an operation system (OS) of the computer architecture 10. As illustrated in FIG. 1, the simulated bus 102 is able to interact with a simulated device 110. The simulated bus 102 can also interact with a physical device 120 via a control module 122.

The simulated device 110 and the simulated bus 102 can operate in different layers of the computer architecture 10 to the physical device 120, the control module 122 and the application program 130. For instance, the simulated device 110 and the simulated bus 102 can operate in a core layer of the operation system in the computer architecture 10, while the physical device 120, the control module 122 and the application program 130 operate in an application layer of the operation system in the computer architecture 10. In another embodiment, the control module 122 maybe comprised in the simulated device 110, so the simulated device 110 can process data received from the physical device 120.

The simulated bus 102 can be generated, for instance, by loading a driver which is in compliance to the Microsoft bus driver standard. The simulated device 110 is generated according to a physical device object (PDO) with designated vendor identification (VID) and product identification (PID) from the simulated bus 102. Once the operation system of the computer architecture 10 has received a message broadcast from the physical device object (PDO), the operation system would recognize the simulated device 110 as a real physical device being added to the computer system according to the designated vendor identification (VID) and product identification (PID) of the simulated device 110.

Once the operation system has recognized the simulated device 110, the operation system searches a corresponding INF file according to the vendor identification (VID) and product identification (PID) of the simulated device 110, for loading the simulated device driver 112 to drive the simulated device 110 accordingly. If the operation system fails to obtain the corresponding INF file, the operation system notifies the user that a driver for the simulated device 110 is not present.

The simulated device driver 112 defines functionalities of the simulated device 110. Conventional simulated devices usually comprise a limited number of functions, and different simulated devices are required for fulfilling needs of different application programs/users. For the simulated device 110 of the present invention to achieve different functions, the corresponding simulated device driver 112 is loaded to drive the simulated device 110. For example, the simulated device driver 112 in compliance with Microsoft AV Stream standard can be loaded, for driving the simulated device 110 to realize video camera functions. The simulated device driver 112 can drive the simulated device 110 to perform functions similar to the physical device 120, and/or act as a function expansion for the physical device 120, etc.

The physical device 120 can be realized with a computer peripheral device such as a video camera, a web camera or a CD/DVD burner etc. The control module 122 is able to process data obtained by the physical device 120 and outputting the processed data to the simulated device 110. For instance, if the physical device 120 comprises a video camera, the control module 122 comprises image processing related functions. When the physical device 120 comprises a video camera, the control module 122 can perform functions such as comparing a resolution requirement requested by the application program 130 to the simulated device 110 with an image resolution provided by the physical device 120. The control module 122 can also convert image data obtained by the physical device 120 according to a resolution requirement of the application program 130, and then output the processed image data to the simulated device 110. Further, the control module 122 can encode the image data obtained by the physical device 120 to a specific codec such as H264 according the request of the application program 130, and output the encoded image data to the simulated device 110. The simulated device 110 can then output the encoded/processed image data to the application program 130.

Since the simulated device 110 is simulated from the simulated bus 102, the simulated device 110 possesses characteristics such as the vendor identification (VID) and the product identification (PID), corresponding to a computer bus (e.g. the simulated bus 102) of the computer architecture 10. This way, the application program 130 can perform certain tasks (e.g. VoIP software like Skype, etc.) according the vendor identification (VID) and the product identification (PID) of the simulated device 110. Authorization may also be granted by the application program 130 (or an external application) to the simulated device 110, according to vendor identification (VID) and product identification (PID) of the simulated device 110.

Characteristics corresponding to a physical device comprised by the simulated device 110 are not limited to the vendor identification and the product identification. Also, the simulated device 110 is not limited to comprise only one vendor identification and/or one product identification. The configuration of the vendor identification and product identification of the simulated device 110 is varied according to the request from the application program 130 (or multiple application programs). The application program 130 can obtain the vendor identification (VID) and the product identification (PID) of the simulated device 110 through an application programming interface (API), for instance. In contrast, conventional simulated devices do not comprise characteristics corresponding to the computer bus (e.g. simulated bus 102) of the computer architecture 10.

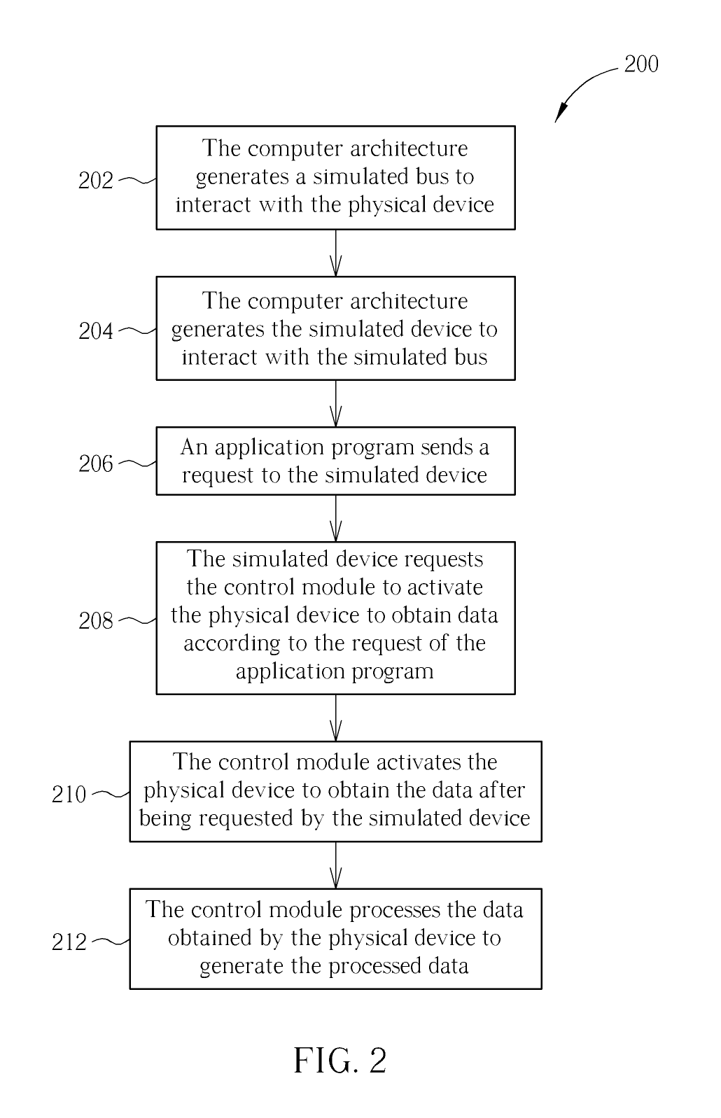

Please refer to FIG. 1 and FIG. 2. FIG. 2 is a flowchart illustrating a method 200 for utilizing a physical device 120 to generate processed data according to an embodiment of the present invention. Steps of the method 200 of the present invention include:

Step 202: the computer architecture 10 generates a simulated bus 102 to interact with the physical device 120;

Step 204: the computer architecture 10 generates the simulated device 110 to interact with the simulated bus 102;

Step 206: an application program 130 sends a request to the simulated device 110;

Step 208: the simulated device 110 requests the control module 122 to activate the physical device 120 to obtain data according to the request of the application program 130;

Step 210: the control module 122 activates the physical device 120 to obtain the data after being requested by the simulated device 110; and

Step 212: the control module 122 processes the data obtained by the physical device 120 to generate the processed data.

After the control module 122 has processed the data obtained by the physical device 120, the processed data is outputted to the simulated device 110 through the simulated bus 102. The simulated device 110 can then output the processed data to the application program 130 so the application program can obtain the processed data from the simulated device 110.

When the simulated device 110 is generated in step 204, the operation system recognizes the simulated device 110 as a real physical device according to the characteristics corresponding to a physical device, such as the vendor identification (VID) and the product identification (PID) of the simulated device 110. For instance, when the simulated device 110 is generated in step 204, the operation system notifies the user that a “physical device” has been installed.

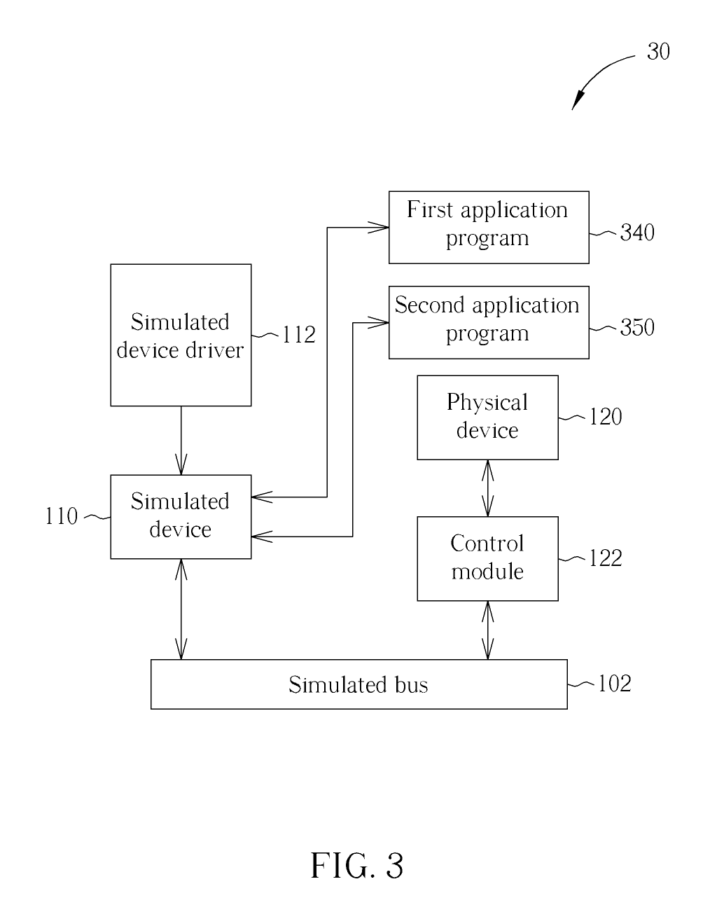

In another embodiment, the simulated device 110 can respond to multiple requests from different application programs at the same time. In other words, the simulated device 110 can output the processed data generated by the physical device 120 to multiple application programs simultaneously. Please refer to FIG. 3. FIG. 3 is a diagram illustrating computer architecture 30 according to an embodiment of the present invention. The computer architecture 30 is similar to the computer architecture 10, and the difference is that the simulated device 110 receives requests from a first application program 340 and a second application program 350 respectively. When the simulated device 110 has received the processed data from the physical device 120 via the simulated bus 102, the simulated device 110 can output the processed data to the first and the second application programs 340 and 350. That is, the second application program 350 can obtain the processed data from the simulated device 110 at the same time as the first application program 340.

In conclusion, the present invention provides a method for utilizing a physical device to generate processed data, and utilizing a simulated device to output the processed data to the application program making the request. The simulated device is generated according to a simulated bus of the computer architecture, and comprises corresponding physical characteristics such as vendor identification (VID) and product identification (PID). When the simulated device is generated, the operation system of the computer architecture treats the simulated device as a real physical device being installed, and the simulated device can be accessed by multiple applications at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for utilizing a physical device to generate processed data, the method comprising:
generating a simulated bus to interact with the physical device;
generating the simulated device to interact with the simulated bus;
a first application program sending a request to the simulated device;
the simulated device requesting a control module to activate the physical device to obtain data according to the request;
the control module activating the physical device to obtain the data after being requested by the simulated device; and
the control module processing the data obtained by the physical device to generate the processed data.

2. The method of claim 1, further comprising outputting the processed data to the simulated device through the simulated bus, and the first application program obtaining the processed data from the simulated device.

3. The method of claim 1, wherein generating the simulated device to interact with the simulated bus comprises generating a physical device object (PDO) with designated vendor identification (VID) and product identification (PID), for interacting with the simulated bus.

4. The method of claim 1, further comprising:
loading a driver to drive the simulated device to function as a video camera.

5. The method of claim 1, further comprising:
the simulated device receiving a request from a first application program; and
when the simulated device has received the processed data, the first application program obtaining the processed data from the simulated device.

6. The method of claim 5, further comprising:
the simulated device receiving a request from a second application program; and
when the simulated device has received the processed data, the second application program obtaining the processed data from the simulated device at the same time as the first application program obtaining the processed data from the simulated device.

7. The method of claim 1, wherein the activating a physical device to obtain data is activating the physical device to obtain image data when the simulated device has received a request from a first application program.
